(19) United States
(12) Patent Application Publication
(10) Pub. No.: US 2025/0330722 A1
(43) Pub. Date: Oct. 23, 2025

(54) ADAPTIVE FOVEATION SENSING SYSTEMS

(71) Applicant: QUALCOMM Incorporated, San Diego, CA (US)

(72) Inventors: Shrey Shailesh GADIYA, Bengaluru (IN); Abhijit DAS, New Delhi (IN); Rohit RANGANATHAN, Hyderabad (IN)

(21) Appl. No.: 18/638,521

(22) Filed: Apr. 17, 2024

(51) Int. Cl. H04N 23/951; G06F 3/01; G06T 3/18; G06T 3/40; H04N 25/42; H04N 25/46

(52) U.S. Cl. CPC H04N 23/951; G06F 3/013; G06T 3/18; G06T 3/40; H04N 25/42; H04N 25/46

(57) ABSTRACT

Disclosed are systems and techniques for processing one or more images. For example, a method includes obtaining, using an image sensor, a first plurality of frames associated with a scene at a first frame rate, wherein the first plurality of frames are associated with a first region of the image sensor and have a first resolution; obtaining, using the image sensor, a second plurality of frames associated with the scene at a second frame rate different from the first frame rate, wherein the second plurality of frames are associated with a second region of the image sensor and have a second resolution that is different from the first resolution; and combining a first frame of the first plurality of frames and a second frame of the second plurality of frames to generate a combined frame.

### FIELD

The present disclosure generally relates to capture and processing of images or frames. For example, aspects of the present disclosure relate to adaptive foveated sensing systems and techniques.

### BACKGROUND

A camera can receive light and capture image frames, such as still images or video frames, using an image sensor. Cameras can be configured with a variety of image-capture settings and/or image-processing settings to alter the appearance of images captured thereby. Image-capture settings may be determined and applied before and/or while an image is captured, such as ISO, exposure time (also referred to as exposure, exposure duration, or shutter speed), aperture size, (also referred to as f/stop), focus, and gain (including analog and/or digital gain), among others. Moreover, image-processing settings can be configured for post-processing of an image, such as alterations to contrast, brightness, saturation, sharpness, levels, curves, and colors, among others.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described herein for performing adaptive foveation. According to aspects described herein, devices using the disclosed adaptive foveation can reduce bandwidth and power consumption based on adaptively controlling frame rates of different regions of a scene.

According to at least one example, a method is provided for capturing one or more frames. The method includes: obtaining, using an image sensor, a first plurality of frames associated with a scene at a first frame rate, wherein the first plurality of frames are associated with a first region of the image sensor and have a first resolution; obtaining, using the image sensor, a second plurality of frames associated with the scene at a second frame rate different from the first frame rate, wherein the second plurality of frames are associated with a second region of the image sensor and have a second resolution that is different from the first resolution; and combining a first frame of the first plurality of frames and a second frame of the second plurality of frames to generate a combined frame.

In another example, an apparatus for generating one or more frames is provided that includes at least one memory and at least one processor (e.g., implemented in circuitry) coupled to the at least one memory and configured to: obtain, from an image sensor, a first plurality of frames associated with a scene at a first frame rate, wherein the first plurality of frames are associated with a first region of the image sensor and have a first resolution; obtain, from the image sensor, a second plurality of frames associated with the scene at a second frame rate different from the first frame rate, wherein the second plurality of frames are associated with a second region of the image sensor and have a second resolution that is different from the first resolution; and combine a first frame of the first plurality of frames and a second frame of the second plurality of frames to generate a combined frame.

In another example, a non-transitory computer-readable medium is provided having stored thereon instructions that, when executed by at least one processor, cause the at least one processor to: obtain, from an image sensor, a first plurality of frames associated with a scene at a first frame rate, wherein the first plurality of frames are associated with a first region of the image sensor and have a first resolution; obtain, from the image sensor, a second plurality of frames associated with the scene at a second frame rate different from the first frame rate, wherein the second plurality of frames are associated with a second region of the image sensor and have a second resolution that is different from the first resolution; and combine a first frame of the first plurality of frames and a second frame of the second plurality of frames to generate a combined frame.

In another example, an apparatus for capturing one or more frames is provided that includes: means for obtaining a first plurality of frames associated with a scene at a first frame rate, wherein the first plurality of frames are associated with a first region of the image sensor and have a first resolution; means for obtaining a second plurality of frames associated with the scene at a second frame rate different from the first frame rate, wherein the second plurality of frames are associated with a second region of the image sensor and have a second resolution that is different from the first resolution; and means for combining a first frame of the first plurality of frames and a second frame of the second plurality of frames to generate a combined frame.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, or any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following drawing figures:

FIG. 1 is a diagram illustrating an example of an image capture and processing system, in accordance with some examples;

FIG. 2A is a diagram illustrating an example of a quad color filter array, in accordance with some examples;

FIG. 2B is a diagram illustrating an example of a binning pattern resulting from application of a binning process to the quad color filter array of FIG. 2A, in accordance with some examples;

FIG. 3 is a diagram illustrating an example of binning of a Bayer pattern, in accordance with some examples;

FIG. 4 is a diagram illustrating an example of an extended reality (XR) system, in accordance with some examples;

FIG. 5 is a block diagram illustrating an example of an XR system with visual see-through (VST) capabilities, in accordance with some examples;

FIGS. 6A and 6B are conceptual illustrations of frames with different foveation regions in accordance with some aspects of the disclosure;

FIG. 7 is a conceptual diagram of an XR system for correcting photometric differences based on foveated stream of images having different field of views (FOVs) in accordance with some aspects of the disclosure;

FIG. 8 is a flowchart illustrating an example process 800 for controlling a frame rate in accordance with some aspects of the disclosure;

FIG. 9 is a block diagram illustrating an example of an XR system with an image sensor configured to perform adaptive foveated sensing in accordance with some aspects of the disclosure

FIG. 10 is a block diagram of an image sensor circuit of FIG. 9, in accordance with some aspects of the disclosure;

FIG. 11 illustrates an example block diagram of an XR system 1100 with an image sensor configured to provide a frame to an image signal processor (ISP) that performs foveation in accordance with some aspects of the disclosure;

FIGS. 12A, 12B, and 12C illustrate operation of a frame rate controller in accordance with some aspects of the disclosure;

FIG. 13 is a flow diagram illustrating an example of a process for generating one or more frames using foveated sensing, in accordance with some examples; and

FIG. 14 is a diagram illustrating an example of a computing system for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Electronic devices (e.g., extended reality (XR) devices such as virtual reality (VR) devices, augmented reality (AR) devices, mixed reality (MR) devices, etc., mobile phones, wearable devices such as smart watches, smart glasses, etc., tablet computers, connected devices, laptop computers, etc.) are increasingly equipped with cameras to capture image frames, such as still images and/or video frames, for consumption. For example, an electronic device can include a camera to allow the electronic device to capture a video or image of a scene, a person, an object, etc. Additionally, cameras themselves are used in a number of configurations (e.g., handheld digital cameras, digital single-lens-reflex (DSLR) cameras, worn camera (including body-mounted cameras and head-borne cameras), stationary cameras (e.g., for security and/or monitoring), vehicle-mounted cameras, etc.).

A camera can receive light and capture image frames (e.g., still images or video frames) using an image sensor (which may include an array of photosensors). In some examples, a camera may include one or more processors, such as image signal processors (ISPs), that can process one or more image frames captured by an image sensor. For example, a raw image frame captured by an image sensor can be processed by an ISP of a camera to generate a final image. In some cases, a camera, or an electronic device implementing a camera, can further process a captured image or video for certain effects (e.g., compression, image enhancement, image restoration, scaling, framerate conversion, etc.) and/or certain applications such as computer vision, extended reality (e.g., augmented reality, virtual reality, and the like), object detection, image recognition (e.g., face recognition, object recognition, scene recognition, etc.), feature extraction, authentication, and automation, among others.

Cameras can be configured with a variety of image-capture settings and/or image-processing settings to alter the appearance of an image. Image-capture settings can be determined and applied before or while an image is captured, such as ISO, exposure time (also referred to as exposure, exposure duration, and/or shutter speed), aperture size (also referred to as f/stop), focus, and gain, among others. Image-processing settings can be configured for post-processing of an image, such as alterations to a contrast, brightness, saturation, sharpness, levels, curves, and colors, among others.

An XR device (e.g., a VR headset or head-mounted display (HMD), an AR headset or HMD, etc.) can output high fidelity images at high resolution and at high frame rates. In XR environments, users are transported into digital worlds where their senses are fully engaged and smooth motion is essential to prevent motion sickness and disorientation, which are common issues experienced at lower frame rates. By displaying images at a high frame rate, typically 90 frames per second (FPS) or above, XR devices can minimize latency and maintain synchronization between the user movements and the visual feedback. Higher frame rates result in a more realistic and comfortable experience and ensure that human neural processing is engaged within the XR environment. Otherwise, the disconnect between the XR environment and the visual feedback received by the user creates motion sickness, disorientation, and nausea.

One application of XR devices is visual see-through (VST), which refers to the capability of XR devices, such as AR glasses or MR headsets, to overlay digital content seamlessly onto the user's real-world view. VST technology enables users to see and interact with their physical surroundings while augmenting them with virtual elements. By tracking the user's head movements and adjusting the position of digital content accordingly, VST technology ensures that virtual objects appear anchored to the real world, creating a convincing and integrated mixed reality experience.

Capturing images with varying resolutions and/or at varying frames rates can lead to a large amount of power consumption and bandwidth usage for systems and devices. For instance, a 16 megapixel (MP) or 20 MP image sensor capturing frames at 90 FPS can require 5.1 to 6.8 Gigabits per second (Gbps) of additional bandwidth. However, such a large amount of bandwidth may not be available on certain devices (e.g., XR devices).

Systems, apparatuses, processes (also referred to as methods), and computer-readable media (collectively referred to as “systems and techniques”) are described herein for performing foveated sensing. For example, foveation is a process for varying detail in an image based on the fovea (e.g., the center of the eye's retina) that can identify salient parts of a scene (e.g., a fovea region) and peripheral parts of the scene (e.g., a peripheral region). In some aspects, an image sensor can be configured to capture a part of a frame in high resolution, which is referred to as a foveated region or a region of interest (ROI), and other parts of the frame at a lower resolution using various techniques (e.g., pixel binning), which is referred to as a peripheral region. In some aspects, an image signal processor can process a foveated region or ROI at a higher resolution and a peripheral region at a lower resolution. In either of such aspects, the image sensor and/or the image signal processor (ISP) can produce high-resolution output for a foveated region where the user is focusing (or is likely to focus) and can produce a low-resolution output (e.g., a binned output) for the peripheral region.

According to various aspects, the systems and techniques can control frame rates for which an image sensor captures various regions (e.g., fovea regions, peripheral regions, etc.) of a field of view (FOV) of the image sensor. For instance, various designs for foveated sensors send a full field of view FOV of an image sensor along with the fovea ROI(s) at same FPS (e.g., at a high FPS such as 60 FPS or 120 FPS) required for a particular application (e.g., for VST XR applications). However, every fovea or full FOV may not need a high FPS at all times. For example, with a steady gaze in a relatively static scene, the peripheral (e.g., full FOV) and in some cases the foveal ROI can be captured at a lower FPS. The systems and techniques described herein provide an event-based adaptive frame rate for different FOVs of an image sensor, which reduce power and bandwidth. For instance, as described in more detail herein, the systems and techniques can detect (e.g., using a frame rate controller and/or frame rate controller logic) certain events that can trigger the capture of an FOV (e.g., a subset of FOVs or all FOVs, such as a first fovea region, a second fovea region, through an n-th fovea region, a full FOV, etc.) at higher frame rate

Additional aspects can include combining a peripheral region with a fovea region. The disclosed systems and techniques enable an XR system to have sufficient bandwidth to enable applications (e.g., VST applications) that use high-quality frames or images (e.g., high-definition (HD) images or video) and synthesize the high-quality frames or images with generated content, thereby creating mixed reality content. The terms frames and images are used herein interchangeably.

As noted previously, according to some aspects, the systems and techniques include adjusting frame rate of a peripheral region based on detected events. In some cases, the events can include intrinsic events and/or extrinsic events. Extrinsic events include events that are not related to the XR device, such as local motion detected within a scene. Intrinsic events include events that are related to the state or operation of the XR device, such as global motion applied to the XR device. The systems and techniques can identify intrinsic and extrinsic events and can control a frame rate for which frames of the peripheral region are captured based on the intrinsic and extrinsic events. For example, for relatively static scenes, an image sensor can capture a peripheral region at a low frame rate (e.g., 30 FPS) without causing adverse effects. In another example, for dynamic scenes (e.g., where objects are moving), an image sensor can capture a peripheral region at a high frame rate (e.g., 60 FPS, 120 FPS, etc.) to prevent adverse effects.

In some aspects, the systems and techniques can blend the fovea region and the peripheral region. In some cases, there can be a time difference between two different frames based on the frame rate, and synthesizing the fovea region and the peripheral region can create visual artifacts that reduce fidelity. The fidelity of the display is important because the human perceptual network may react adversely to artifacts. For instance, the artifacts can cause motion sickness. In some examples, the systems and techniques can warp the peripheral region based on motion detected in XR devices. In some cases, the photometric differences of the fovea region and the peripheral region can also create visual artifacts. The systems and techniques can correct the photometric differences to ensure that the synthesized image has high visual fidelity.

The systems and techniques described herein provide various benefits and advantages. For example, the systems and techniques can save image sensor and transmission power by selectively exposing only a non-contiguous subset of the image sensor FOV, as dictated by the event detection logic. The systems and techniques also provide a mechanism to assimilate and process a full frame (corresponding to a full FOV of the image sensor) with different regions sampled at different FPS. The assimilated stream can have a higher frame rate in a specified ROI (e.g., a fovea region), while stable background regions can be refreshed at a lower rate. Such a solution can reduce the number (e.g., on average) of pixels exposed in the sensor. The solution can increase an opportunity for sensor circuits to enter low power modes, reducing sensor power. The transmission bandwidth is also considerably reduced. Such a solution can provide an improvement over only downscaling a full FOV (where all sensor pixels are still exposed and only transmit power is saved). The systems and techniques provide a high FPS render (which can be important for various systems, such as XR systems), but at reduced bandwidth and power of the image sensor and with no degradation in the fovea region in terms of quality.

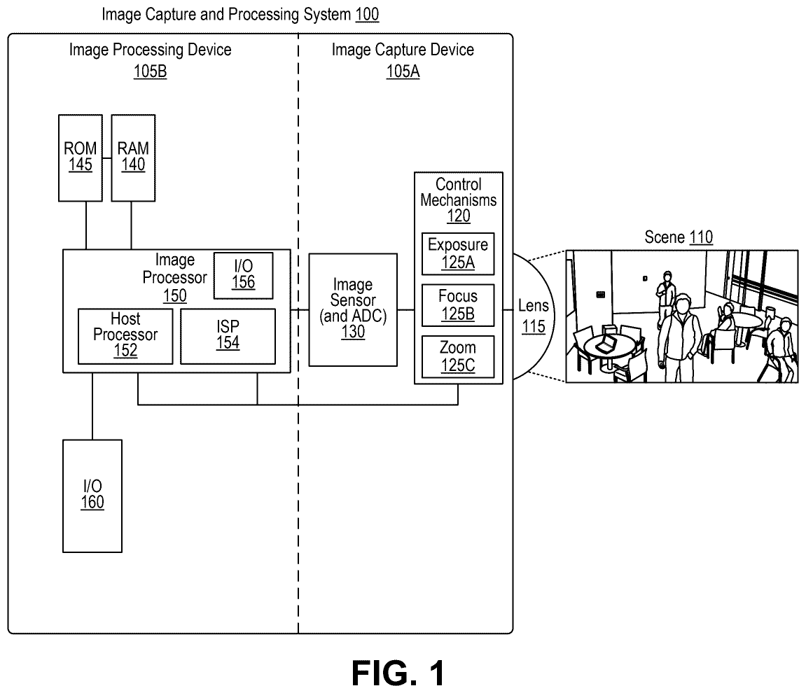

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the image capture and processing system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, high dynamic range (HDR), depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f-stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

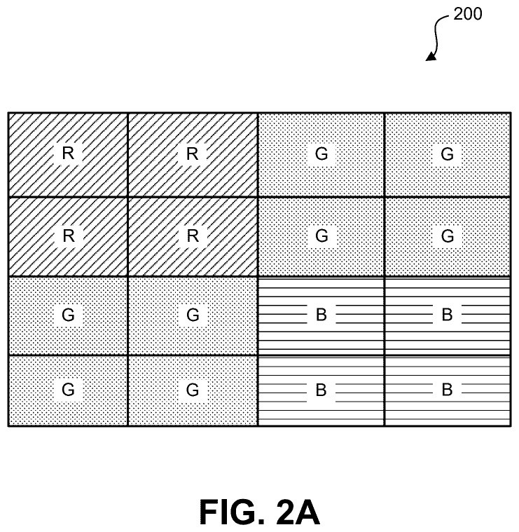

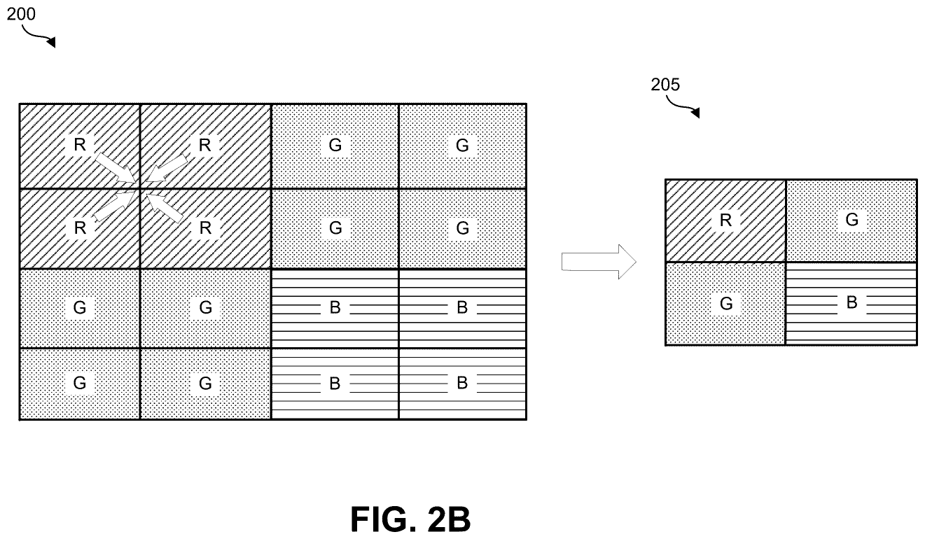

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters of a color filter array, and may thus measure light matching the color of the color filter covering the photodiode. Various color filter arrays can be used, including a Bayer color filter array, a quad color filter array (also referred to as a quad Bayer filter), and/or other color filter array. FIG. 2A is a diagram illustrating an example of a quad color filter array 200. As shown, the quad color filter array 200 includes a 2×2 (or “quad”) pattern of color filters, including a 2×2 pattern of red (R) color filters, a pair of 2×2 patterns of green (G) color filters, and a 2×2 pattern of blue (B) color filters. The pattern of the quad color filter array 200 shown in FIG. 2A is repeated for the entire array of photodiodes of a given image sensor. As shown, the Bayer color filter array includes a repeating pattern of red color filters, blue color filters, and green color filters. Using either quad color filter array or the Bayer color filter array, each pixel of an image is generated based on red light data from at least one photodiode covered in a red color filter of the color filter array, blue light data from at least one photodiode covered in a blue color filter of the color filter array, and green light data from at least one photodiode covered in a green color filter of the color filter array. Other types of color filter arrays may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for PDAF. The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more ISPs (including ISP 154), one or more host processors (including host processor 152), and/or one or more of any other type of processor 1410 discussed with respect to the computing system 1400. The host processor 152 can be a digital signal processor (DSP) and/or other type of processor. The image processor 150 may store image frames and/or processed images in random access memory (RAM) 140/1125, read-only memory (ROM) 145/1420, a cache 1412, a memory unit 1415, another storage device 1430, or some combination thereof.

In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The host processor 152 of the image processor 150 can configure the image sensor 130 with parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames. The host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. For example, the processing blocks or modules of the ISP 154 can perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The settings of different modules of the ISP 154 can be configured by the host processor 152.

The image processing device 105B can include various input/output (I/O) devices 160 connected to the image processor 150. The I/O devices 160 can include a display screen, a keyboard, a keypad, a touchscreen, a trackpad, a touch-sensitive surface, a printer, any other output devices 1935, any other input devices 1945, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

As noted above, a color filter array can cover the one or more arrays of photodiodes (or other photosensitive elements) of the image sensor 130. The color filter array can include a quad color filter array in some implementations, such as the quad color filter array 200 shown in FIG. 2A. In certain situations, after an image is captured by the image sensor 130 (e.g., before the image is provided to and processed by the ISP 154), the image sensor 130 can perform a binning process to bin the quad color filter array 200 pattern into a binned Bayer pattern. For instance, as shown in FIG. 2B (described below), the quad color filter array 200 pattern can be converted to a Bayer color filter array pattern (with reduced resolution) by applying the binning process. The binning process can increase signal-to-noise ratio (SNR), resulting in increased sensitivity and reduced noise in the captured image. In one illustrative example, binning can be performed in low-light settings when lighting conditions are poor, which can result in a high quality image with higher brightness characteristics and less noise.

FIG. 2B is a diagram illustrating an example of a binning pattern 205 resulting from application of a binning process to the quad color filter array 200. The example illustrated in FIG. 2B is an example of a binning pattern 205 that results from a 2×2 quad color filter array binning process, where an average of each 2×2 set of pixels in the quad color filter array 200 results in one pixel in the binning pattern 205. For example, an average of the four pixels captured using the 2×2 set of red (R) color filters in the quad color filter array 200 can be determined. The average R value can be used as the single R component in the binning pattern 205. An average can be determined for each 2×2 set of color filters of the quad color filter array 200, including an average of the top-right pair of 2×2 green (G) color filters of the quad color filter array 200 (resulting in the top-right G component in the binning pattern 205), the bottom-left pair of 2×2 G color filters of the quad color filter array 200 (resulting in the bottom-left G component in the binning pattern 205), and the 2×2 set of blue (B) color filters (resulting in the B component in the binning pattern 205) of the quad color filter array 200.

The size of the binning pattern 205 is a quarter of the size of the quad color filter array 200. As a result, a binned image resulting from the binning process is a quarter of the size of an image processed without binning. In one illustrative example where a 48 megapixel (48 MP or 48 M) image is captured by the image sensor 130 using a 2×2 quad color filter array 200, a 2×2 binning process can be performed to generate a 12 MP binned image. The reduced-resolution image can be upsampled (upscaled) to a higher resolution in some cases (e.g., before or after being processed by the ISP 154).

In some examples, when binning is not performed, a quad color filter array pattern can be remosaiced (using a remosaicing process) by the image sensor 130 to a Bayer color filter array pattern. For example, the Bayer color filter array is used in many ISPs. To utilize all ISP modules or filters in such ISPs, a remosaicing process may need to be performed to remosaic from the quad color filter array 200 pattern to the Bayer color filter array pattern. The remosaicing of the quad color filter array 200 pattern to a Bayer color filter array pattern allows an image captured using the quad color filter array 200 to be processed by ISPs that are designed to process images captured using a Bayer color filter array pattern.

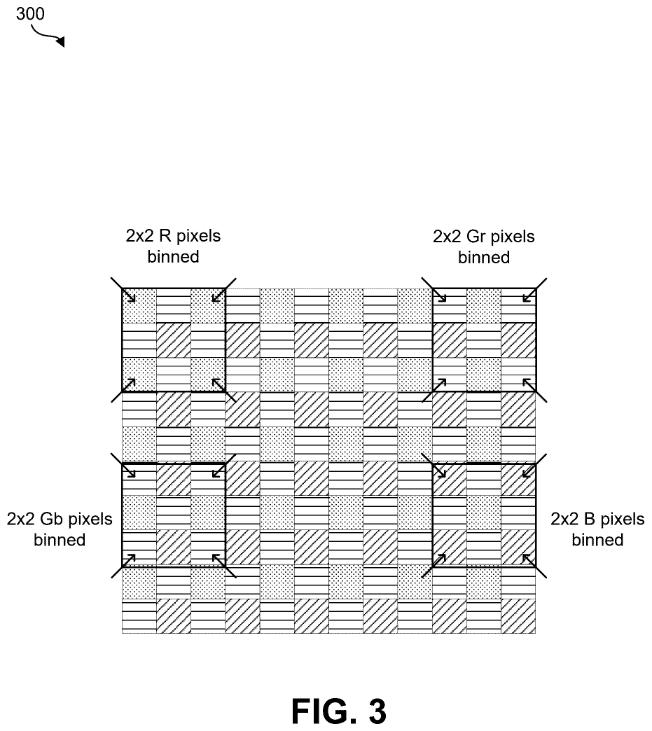

FIG. 3 is a diagram illustrating an example of a binning process applied to a Bayer pattern of a Bayer color filter array 300. As shown, the binning process bins the Bayer pattern by a factor of two both along the horizontal and vertical direction. For example, taking groups of two pixels in each direction (as marked by the arrows illustrating binning of a 2×2 set of red (R) pixels, two 2×2 sets of green (Gr) pixels, and a 2×2 set of blue (B) pixels), a total of four pixels are averaged to generate an output Bayer pattern that is half the resolution of the input Bayer pattern of the Bayer color filter array 300. The same operation may be repeated across all of the red, blue, green (beside the red pixels), and green (beside the blue pixels) channels.

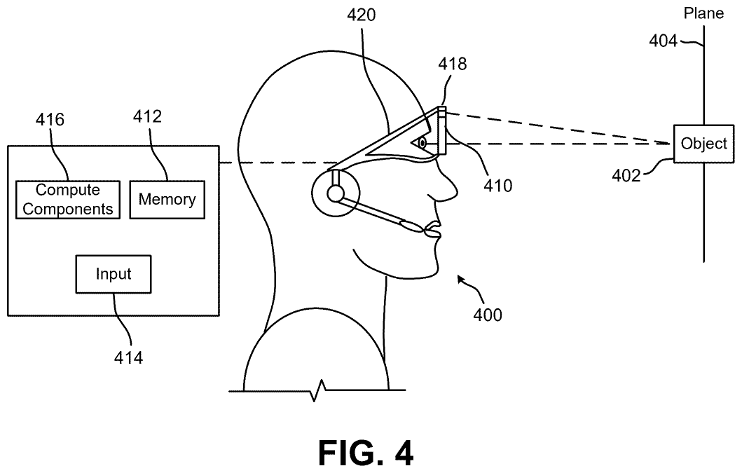

FIG. 4 is a diagram illustrating an example of an extended reality system 420 being worn by a user 400. While the extended reality system 420 is shown in FIG. 4 as AR glasses, the extended reality system 420 can include any suitable type of XR system or device, such as an HMD or other XR device. The extended reality system 420 is described as an optical see-through AR device, which allows the user 400 to view the real world while wearing the extended reality system 420. For example, the user 400 can view an object 402 in a real-world environment on a plane 404 at a distance from the user 400. The extended reality system 420 has an image sensor 418 and a display 410 (e.g., a glass, a screen, a lens, or other display) that allows the user 400 to see the real-world environment and also allows AR content to be displayed thereon. While one image sensor 418 and one display 410 are shown in FIG. 4, the extended reality system 420 can include multiple cameras and/or multiple displays (e.g., a display for the right eye and a display for the left eye) in some implementations. In some aspects, the extended reality system 420 can include an eye sensor for each eye (e.g., a left eye sensor, a right eye sensor) configured to track a location of each eye, which can be used to identify a focal point with the extended reality system 420. AR content (e.g., an image, a video, a graphic, a virtual or AR object, or other AR content) can be projected or otherwise displayed on the display 410. In one example, the AR content can include an augmented version of the object 402. In another example, the AR content can include additional AR content that is related to the object 402 or related to one or more other objects in the real-world environment.

As shown in FIG. 4, the extended reality system 420 can include, or can be in wired or wireless communication with, compute components 416 and a memory 412. The compute components 416 and the memory 412 can store and execute instructions used to perform the techniques described herein. In implementations where the extended reality system 420 is in communication (wired or wirelessly) with the memory 412 and the compute components 416, a device housing the memory 412 and the compute components 416 may be a computing device, such as a desktop computer, a laptop computer, a mobile phone, a tablet, a game console, or other suitable device. The extended reality system 420 also includes or is in communication with (wired or wirelessly) an input device 414. The input device 414 can include any suitable input device, such as a touchscreen, a pen or other pointer device, a keyboard, a mouse a button or key, a microphone for receiving voice commands, a gesture input device for receiving gesture commands, any combination thereof, and/or other input device. In some cases, the image sensor 418 can capture images that can be processed for interpreting gesture commands.

The image sensor 418 can capture color images (e.g., images having red-green-blue (RGB) color components, images having luma (Y) and chroma (C) color components such as YCbCr images, or other color images) and/or grayscale images. As noted above, in some cases, the extended reality system 420 can include multiple cameras, such as dual front cameras and/or one or more front and one or more rear-facing cameras, which may also incorporate various sensors. In some cases, image sensor 418 (and/or other cameras of the extended reality system 420) can capture still images and/or videos that include multiple video frames (or images). In some cases, image data received by the image sensor 418 (and/or other cameras) can be in a raw uncompressed format, and may be compressed and/or otherwise processed (e.g., by an ISP or other processor of the extended reality system 420) prior to being further processed and/or stored in the memory 412. In some cases, image compression may be performed by the compute components 416 using lossless or lossy compression techniques (e.g., any suitable video or image compression technique).

In some cases, the image sensor 418 (and/or other camera of the extended reality system 420) can be configured to also capture depth information. For example, in some implementations, the image sensor 418 (and/or other camera) can include an RGB-depth (RGB-D) camera. In some cases, the extended reality system 420 can include one or more depth sensors (not shown) that are separate from the image sensor 418 (and/or other camera) and that can capture depth information. For instance, such a depth sensor can obtain depth information independently from the image sensor 418. In some examples, a depth sensor can be physically installed in a same general location as the image sensor 418, but may operate at a different frequency or frame rate from the image sensor 418. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

In some implementations, the extended reality system 420 includes one or more sensors. The one or more sensors can include one or more accelerometers, one or more gyroscopes, one or more inertial measurement units (IMUs), and/or other sensors. For example, the extended reality system 420 can include at least one eye sensor that detects a position of the eye that can be used to determine a focal region that the person is looking at in a parallax scene. The one or more sensors can provide velocity, orientation, and/or other position-related information to the compute components 416. As noted above, in some cases, the one or more sensors can include at least one IMU. An IMU is an electronic device that measures the specific force, angular rate, and/or the orientation of the extended reality system 420, using a combination of one or more accelerometers, one or more gyroscopes, and/or one or more magnetometers. In some examples, the one or more sensors can output measured information associated with the capture of an image captured by the image sensor 418 (and/or other camera of the extended reality system 420) and/or depth information obtained using one or more depth sensors of the extended reality system 420.

The output of one or more sensors (e.g., one or more IMUs) can be used by the compute components 416 to determine a pose of the extended reality system 420 (also referred to as the head pose) and/or the pose of the image sensor 418. In some cases, the pose of the extended reality system 420 and the pose of the image sensor 418 (or other camera) can be the same. The pose of image sensor 418 refers to the position and orientation of the image sensor 418 relative to a frame of reference (e.g., with respect to the object 402). In some implementations, the camera pose can be determined for 6-Degrees Of Freedom (6DOF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference).

In some aspects, the pose of image sensor 418 and/or the extended reality system 420 can be determined and/or tracked by the compute components 416 using a visual tracking solution based on images captured by the image sensor 418 (and/or other camera of the extended reality system 420). In some examples, the compute components 416 can perform tracking using computer vision-based tracking, model-based tracking, and/or simultaneous localization and mapping (SLAM) techniques. For instance, the compute components 416 can perform SLAM or can be in communication (wired or wireless) with a SLAM engine (now shown). SLAM refers to a class of techniques where a map of an environment (e.g., a map of an environment being modeled by extended reality system 420) is created while simultaneously tracking the pose of a camera (e.g., image sensor 418) and/or the extended reality system 420 relative to that map. The map can be referred to as a SLAM map, and can be three-dimensional (3D). The SLAM techniques can be performed using color or grayscale image data captured by the image sensor 418 (and/or other camera of the extended reality system 420), and can be used to generate estimates of 6DOF pose measurements of the image sensor 418 and/or the extended reality system 420. Such a SLAM technique configured to perform 6DOF tracking can be referred to as 6DOF SLAM. In some cases, the output of one or more sensors can be used to estimate, correct, and/or otherwise adjust the estimated pose.

In some cases, the 6DOF SLAM (e.g., 6DOF tracking) can associate features observed from certain input images from the image sensor 418 (and/or other camera) to the SLAM map. 6DOF SLAM can use feature point associations from an input image to determine the pose (position and orientation) of the image sensor 418 and/or extended reality system 420 for the input image. 6DOF mapping can also be performed to update the SLAM Map. In some cases, the SLAM map maintained using the 6DOF SLAM can contain 3D feature points triangulated from two or more images. For example, key frames can be selected from input images or a video stream to represent an observed scene. For every key frame, a respective 6DOF camera pose associated with the image can be determined. The pose of the image sensor 418 and/or the extended reality system 420 can be determined by projecting features from the 3D SLAM map into an image or video frame and updating the camera pose from verified 4D-3D correspondences.

In one illustrative example, the compute components 416 can extract feature points from every input image or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The features points in key frames either match (are the same or correspond to) or fail to match the features points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Speed Up Robust Features (SURF), Gradient Location-Orientation histogram (GLOH), Normalized Cross Correlation (NCC), or other suitable technique.

In some examples, virtual objects (e.g., AR objects) can be registered or anchored to (e.g., positioned relative to) the detected features points in a scene. For example, the user 400 can be looking at a restaurant across the street from where the user 400 is standing. In response to identifying the restaurant and virtual content associated with the restaurant, the compute components 416 can generate a virtual object that provides information related to the restaurant. The compute components 416 can also detect feature points from a portion of an image that includes a sign on the restaurant, and can register the virtual object to the feature points of the sign so that the AR object is displayed relative to the sign (e.g., above the sign so that it is easily identifiable by the user 400 as relating to that restaurant).

The extended reality system 420 can generate and display various virtual objects for viewing by the user 400. For example, the extended reality system 420 can generate and display a virtual interface, such as a virtual keyboard, as an AR object for the user 400 to enter text and/or other characters as needed. The virtual interface can be registered to one or more physical objects in the real world. However, in many cases, there can be a lack of real-world objects with distinctive features that can be used as reference for registration purposes. For example, if a user is staring at a blank whiteboard, the whiteboard may not have any distinctive features to which the virtual keyboard can be registered. Outdoor environments may provide even less distinctive points that can be used for registering a virtual interface, for example based on the lack of points in the real world, distinctive objects being further away in the real world than when a user is indoors, the existence of many moving points in the real world, points at a distance, among others.

In some examples, the image sensor 418 can capture images (or frames) of the scene associated with the user 400, which the extended reality system 420 can use to detect objects and humans/faces in the scene. For example, the image sensor 418 can capture frames/images of humans/faces and/or any objects in the scene, such as other devices (e.g., recording devices, displays, etc.), windows, doors, desks, tables, chairs, walls, etc. The extended reality system 420 can use the frames to recognize the faces and/or objects captured by the frames and estimate a relative location of such faces and/or objects. To illustrate, the extended reality system 420 can perform facial recognition to detect any faces in the scene and can use the frames captured by the image sensor 418 to estimate a location of the faces within the scene. As another example, the extended reality system 420 can analyze frames from the image sensor 418 to detect any capturing devices (e.g., cameras, microphones, etc.) or signs indicating the presence of capturing devices, and estimate the location of the capturing devices (or signs).

The extended reality system 420 can also use the frames to detect any occlusions within a FOV of the user 400 that may be located or positioned such that any information rendered on a surface of such occlusions or within a region of such occlusions are not visible to, or are out of a FOV of, other detected users or capturing devices. For example, the extended reality system 420 can detect the palm of the hand of the user 400 is in front of, and facing, the user 400 and thus within the FOV of the user 400. The extended reality system 420 can also determine that the palm of the hand of the user 400 is outside of a FOV of other users and/or capturing devices detected in the scene, and thus the surface of the palm of the hand of the user 400 is occluded from such users and/or capturing devices. When the extended reality system 420 presents any AR content to the user 400 that the extended reality system 420 determines should be private and/or protected from being visible to the other users and/or capturing devices, such as a private control interface as described herein, the extended reality system 420 can render such AR content on the palm of the hand of the user 400 to protect the privacy of such AR content and prevent the other users and/or capturing devices from being able to see the AR content and/or interactions by the user 400 with that AR content.

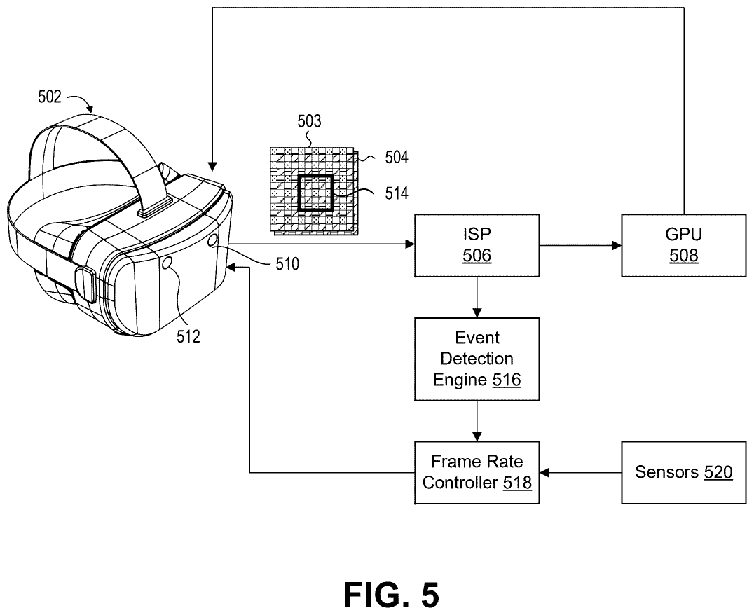

FIG. 5 illustrates an example of an XR system 502 with VST capabilities that can generate frames or images of a physical scene in the real-world by processing sensor data 503, 504 using an ISP 506 and a GPU 508. As noted above, virtual content can be generated and displayed with the frames/images of the real-world scene, resulting in mixed reality content.

In the example XR system 502 of FIG. 5, the bandwidth requirement that is needed for VST in XR is high. There is also a high demand for increased resolution to improve visual fidelity of the displayed frames or images, which requires a higher capacity image sensor, such as a 16 MP or 20 MP image sensor. Further, there is demand for increased framerate for XR applications, as lower framerates (and higher latency) can affect a person's senses and cause real world effects such as nausea. Higher resolution and higher framerates may result in an increased memory bandwidth and power consumption beyond the capacity of some existing memory systems.

In some aspects, an XR system 502 can include image sensors 510 and 512 (or VST sensors) corresponding to each eye. For example, a first image sensor 510 can capture the sensor data 503 and a second image sensor 512 can capture the sensor data 504. The two image sensors 510 and 512 can send the sensor data 503, 504 to the ISP 506. The ISP 506 processes the sensor data (to generate processed frame data) and passes the processed frame data to the GPU 508 for rendering an output frame or image for display. For example, the GPU 508 can augment the processed frame data by superimposing virtual data over the processed frame data.

In some cases, using an image sensor with 16 MP to 20 MP at 90 FPS may require 5.1 to 6.8 Gigabits per second (Gbps) of additional bandwidth for the image sensor. This bandwidth may not be available because memory (e.g., DDR memory) in current systems is typically already stretched to the maximum possible capacity. Improvements to limit the bandwidth, power, and memory are needed to support mixed reality applications using VST.

In some aspects, human vision sees only a fraction of the field of view at the center (e.g., 10 degrees) with high resolution. In general, the salient parts of a scene draw human attention more than the non-salient parts of the scene. Illustrative examples of salient parts of a scene include moving objects in a scene, people or other animated objects (e.g., animals), faces of a person, or important objects in the scene such as an object with a bright color.

In some aspects, systems and techniques may use foveation sensing to reduce bandwidth and power consumption of a system (e.g., an XR system, mobile device or system, a system of a vehicle, etc.). For example, the sensor data 503 and the sensor data 504 may be separated into two frames, processed independently, and combined at an output stage. For example, a foveation region 514 may be preserved with high fidelity and the peripheral region (e.g., the sensor data 503) may be downsampled to a lower resolution.

In some cases, the peripheral region can be adaptively controlled based on different extrinsic and intrinsic properties of the system. For example, gaze of a user can be steady in a relatively static scene and the peripheral region (e.g., the full FOV) can be captured at a lower frame rate. In some cases, the fovea region (e.g., the partial FOV) can be captured at a lower frame rate. By reducing the frame rate, bandwidth can be reduced and power can be preserved.

The XR system 502 includes an event detection engine 516 to detect intrinsic and extrinsic events, and a frame rate controller 518 is configured to control the frame rate of the different regions (e.g., the peripheral region, the fovea region, etc.) based on the intrinsic and extrinsic events.

Intrinsic events refer to events that are directly related to the operation, functionality, or state of the XR system 502. For example, non-limiting intrinsic events include a focal region change of the user, global motion detected by the XR system 502 (e.g., the user rotating their head to view a different scene). Global motion encompasses the overall movement of the entire scene and occurs based on motion applied to the XR system 502. For example, global motion occurs when a user of the XR system 502 rotates their head or moves their body (e.g. displacement of the XR system 502).

Extrinsic events in the context of XR devices are events that originate from external sources or factors outside of the XR system 502 but affect the operation, functionality, or user experience. For example, non-limiting extrinsic events include changes in lighting conditions and local motion in the scene. Local motion refers to the movement of objects or elements within a specific region or area of the frame. That is, local motion is the motion of individual components within the scene such as, for example, objects shifting positions, people walking, vehicles moving, or any other form of movement that occurs within a confined portion of the video frame. In some cases, foveation is based on gaze detection and a region of interest (e.g., a focal region) of the user. The gaze of a user can change based on intrinsic or extrinsic events. Extrinsic events can include events that are not related to the XR device, such as local motion detected within a scene (e.g., a user interface element moves into the field of view). Intrinsic events can include events that are related to the state or operation of the XR device, such as global motion applied to the XR device. The systems and techniques can identify intrinsic and extrinsic events and can control a frame rate for which frames of the peripheral region are captured based on the intrinsic and extrinsic events.

In some aspects, the event detection engine 516 is configured to detect different intrinsic events and various qualities of the events. For example, the event detection engine 516 can detect global motion applied to the XR system 502. The event detection engine 516 can also detect with the global motion is deemed to end. The event detection engine 516 can also detect local motion within the scene, detect scene characteristics (e.g., lighting conditions), gaze change, and provide the information the frame rate controller 518.

The frame rate controller 518 can use the events detected by the event detection engine 516 and determines the frame rate of the different regions (e.g., the fovea region, the peripheral region). For example, in the event the local motion, global motion, the scene characteristics, and gaze region are stable, the frame rate controller 518 may reduce the frame rate of the peripheral region while maintaining the fovea region at a constant frame (e.g., 120 FPS). In some cases, the frame rate controller 518 may also reduce the frame frate of the fovea region.

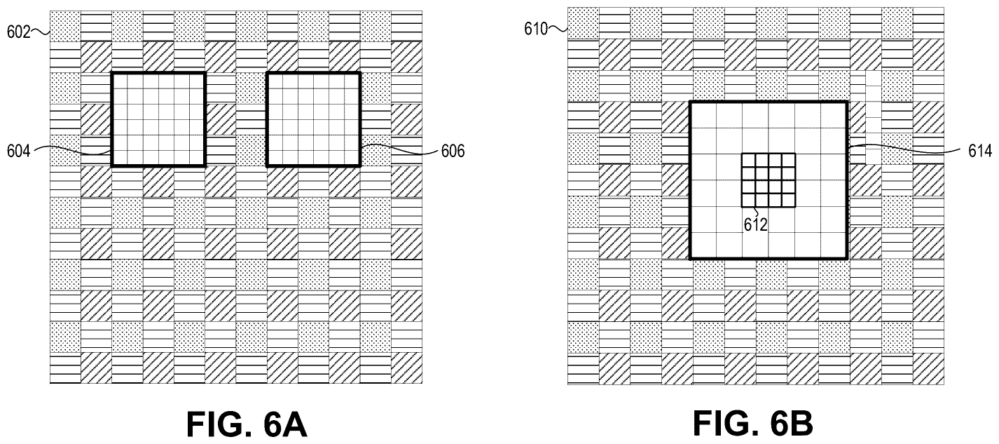

FIG. 6A is a conceptual illustration of a frame 602 with a full FOV and includes a first fovea region 604 with a partial FOV, and a second fovea region 606 with a partial FOV. As shown in the frame 602, the fovea region 604 region is a focal region (e.g., an ROI) having a higher resolution than the frame 602. In one aspect, the fovea region 606 is another ROI (e.g., an area of local motion) and also has a higher resolution than the frame 602. For example, the XR system may detect that the local motion may cause the gaze of the user to change to the fovea region.

FIG. 6B in another conceptual illustration of a frame 610 with a full FOV and includes a first fovea region 612 that is within a second fovea region 614. The frame 610 has the lowest resolution, the first fovea region 612 has the highest resolution, and the second fovea region has an intermediate resolution. In this case, the fovea regions are gradients between highest resolution and lowest resolution to reduce image artifacts and blending issues. The first fovea region 612, and the second fovea region 614 may also have a different frame rate (e.g., the frame 610 is output by an image sensor at 30 FPS, the first fovea region 612 is output at 120 FPS, and the second fovea region 614 is output at 60 FPS).

That is, the XR system can include multiple overlapping fovea regions that have different resolutions to improve image fidelity. Each region has a different frame rate (e.g., 30 FPS, 120 FPS).

The XR system is configured to generate multiple streams of images having different resolutions and different frame rates. A stream refers to a sequence of data elements that are made available over time, such as a stream of images from an image sensor and often are used to represent continuous or dynamically changing data. Streams provide a flexible and efficient mechanism to handle potentially large or infinite datasets without loading the entire set of data (e.g., images) entirely into memory at once, and allow for sequential processing of data. The processing of streams allows applications to work with data incrementally, reducing memory usage and improving performance.

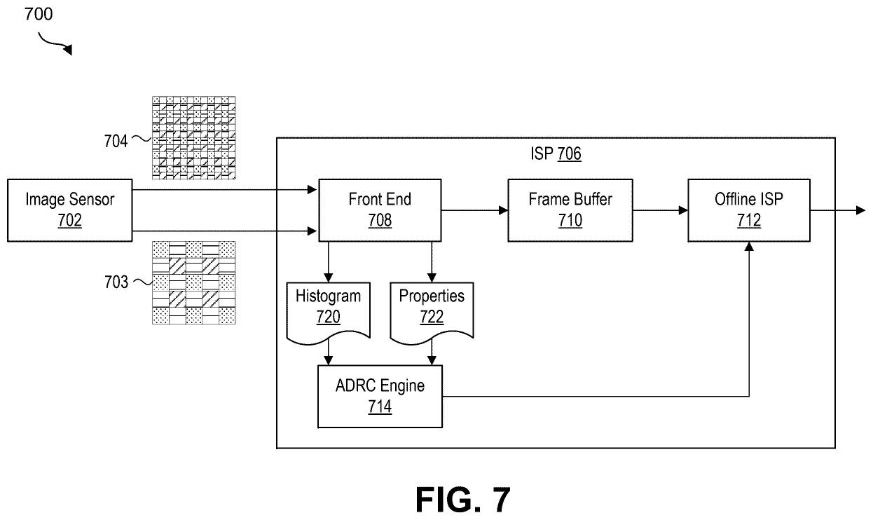

FIG. 7 is a conceptual diagram of an XR system 700 for correcting photometric differences based on foveated stream of images having different FOVs in accordance with some aspects of the disclosure. In some aspects, the each region (e.g., ROI) may be sampled at different time points with different exposure settings. For example, an exposure time of a high frame rate stream will be different from an exposure time of a low frame rate stream. The XR system 700 is configured to compute and generate spatial modifiers to dynamic range control (DRC) gains to be applied over the aggregated frame in the offline ISP.

For example, the XR system 700 includes an image sensor 702 that is configured to generate a first stream of images 703 having a full FOV and a second stream of images 704 having a partial FOV. For example, the image sensor 702 may bin the images to generate the lower resolution. The second stream of images 704 is also captured at a higher frame rate (e.g., 120 FPS) as compared to the first stream of images 704 (e.g., 30 FPS). The first stream of images 703 and the second stream of images 704 are provided to an ISP 706.

The ISP 706 includes a front end 708, a frame buffer 710, an offline ISP 712, and an adaptive dynamic range compression (ADRC) engine 714. The front end 708 provides an initial stage of processing that occurs to manipulate raw image sensor data captured by a camera. For example, front end 708 performs tasks such as demosaicing (e.g., converting raw sensor data into full-color images), color correction, white balance adjustment, noise reduction, and lens distortion correction. The front end 708 may store the first stream of images 703 and the second stream of images 704 in the frame buffer 710. In other cases, the front end 708 may store the first stream of images 703 and the second stream of images 704 in an external memory.

In one aspect, the front end 708 may also generate a histogram 720 associated with images from the first stream of images 703 and the second stream of images 704. The histogram 720 represents the range of possible pixel intensity values on a first axis (e.g., x-axis) and the other axis (e.g., y-axis) represents the frequency or number of pixels in the image that have a particular intensity value. The histogram 720 provides a visual summary of the tonal distribution of the image, indicating how many pixels fall into each intensity value range.

The front end 708 may also generate various statistics 722 associated with images from the first stream of images 703 and the second stream of images 704. The statistics 722 associated with an image and includes properties, distribution, and characteristics. Common statistical metrics include measures of central tendency such as mean, median, and mode, which provide insights into the average brightness or color of the image. A mean intensity reflects the average pixel value across the entire image, while median intensity represents the middle value when all pixel intensities are arranged in ascending order, offering robustness to outliers. The mode indicates the most frequently occurring intensity value in the image, highlighting dominant features.

In addition, the statistics 722 may also include measures of dispersion or variability, such as standard deviation and variance. Standard deviation quantifies the spread of pixel intensities around the mean, indicating the level of contrast or variability within the image. A higher standard deviation suggests greater variability in pixel values, leading to a more diverse range of tones or colors. Variance, which is the square of the standard deviation, provides a measure of the average squared deviation of pixel intensities from the mean, offering further insights into the image's distribution and texture.

The histogram 720 and statistics 722 are provided to the ADRC engine 714. In some aspects, when the ADRC engine 714 detects photometric differences between the images 703 and the images 704, the ADRC engine 714 computes blend parameters to be applied to the images. For example, the ADRC engine 714 uses the histogram 720 and statistics 722 of different images to identify the photometric differences between different images, which can also include differences in time between the different frames. In some aspects, the blend parameters may include spatial gain modifiers to correct the exposure for previous ROI's and match the exposure to the fovea region, which has the highest FPS.

The offline ISP 712 ISP refers image processing that occurs after the raw sensor data has been captured and stored. The offline ISP 712 may use computationally intensive algorithms and techniques for advanced image enhancement, feature extraction, object recognition, or other tasks that require deeper analysis of the image data. In some aspects, the offline ISP 712 may perform operations on the foveated regions (e.g., the second stream of images 704) to improve image fidelity, and may perform minimal or no operations on the peripheral region (e.g., the first stream of images 703) that have less significance. The offline ISP 712 can process the foveated regions in real-time based on limiting the processing to the foveated regions.

In some aspects, the offline ISP 712 also receives the blend parameters from the ADRC engine 714 and can control the blending of the foveated region and the peripheral regions to minimize differences between the pixels and provide high visual fidelity.

Although the XR system 700 illustrates that the ISP 706 is configured to blend the first stream of images 703 and the second stream of images 704, other components in the system 700 may also be configured to blend the different regions. For example, a GPU may be configured to blend the first stream of images 703 and the second stream of images 704 based on additional motion to account for motion of the XR system 700 or within the scene and improve visual fidelity.

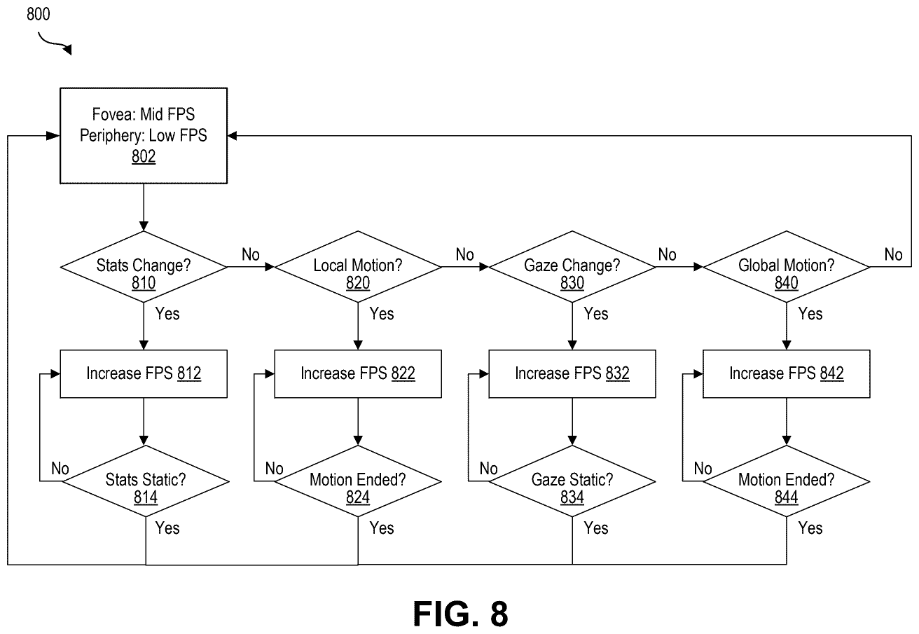

FIG. 8 is a flowchart illustrating an example process 800 for controlling a frame rate in accordance with some aspects of the disclosure. The process 800 can be performed by a computing device (or apparatus) or a component (e.g., a chipset, codec, etc.) of the computing device. The computing device may be a mobile device (e.g., a mobile phone), a network-connected wearable such as a watch, an XR device (e.g., a VR device or AR device), a vehicle or component or system of a vehicle, or other types of computing device. The operations of the process 800 may be implemented as software components that are executed and run on one or more processors. In some aspects, the example process 800 illustrates execution of the process 800 over multiple frames and continually executes while providing foveated content to an XR device.

At block 802, the computing device is presumed to be in a steady state operation of the device, with a fovea region having a high FPS (e.g., 120 FPS, 60 FPS, etc.) and a peripheral region having a low frame rate (e.g., 30 FPS). In this case, the foveated region is presumed to have a fixed frame rate (e.g., 120 FPS) for purposes of illustration. However, the foveated region may also be adaptive and may change based on the following.

At block 810, the computing device may determine if statistics of a next image (e.g., the histogram 720 or the statistics 722) have changed. For example, if luminance of the next image is different from the luminance of a current image, the computing device determines the statistics change. If the computing device determines that the statistics have changed at block 810, the computing device proceeds to block 812. For example, if the statistics are greater than a threshold, the computing device determines that the statistics have changed and there is a difference between two subsequent frames. In this case, the high frame rate should be maintained. However, if the computing device determines that the statistics have not changed at block 810, the computing device proceeds to block 820.

At block 812, the computing device may increase the frame rate of the peripheral region. For example, the computing device may increase the frame rate to 60 FPS.

At block 814, the computing device may then determine if the statistics are deemed to be static and are not changing. If the computing device determines the statistics are not static and continue to vary by frame, the computing device may return to block 812 to increase the frame rate (e.g., to 90 FPS) or maintain the current frame rate. If the computing device determines the statistics are static and have stabilized, the computing device may return to block 802 to return to steady state operation.

At block 820, the computing device may determine if the local motion within a next image is detected. For example, if an object within a peripheral region or fovea region has moved between two successive frames, the computing device determines there is local motion within the scene. For example, the computing device can determine that there is local motion if an object moves a threshold distance between two or more successive frames. If the computing device determines there is local motion at block 820, the computing device proceeds to block 822. However, if the computing device determines there is no local motion at block 820, the computing device proceeds to block 830.

At block 822, the computing device may increase the frame rate of the peripheral region. For example, the computing device may increase the frame rate to 60 FPS.

At block 824, the computing device may then determine the local motion has ended. If the computing device determines the local motion is continuing, the computing device may return to block 822 to increase the frame rate (e.g., to 90 FPS) or maintain the current frame rate. If the computing device determines the local motion has ended, the computing device may return to block 802 to return to steady state operation.

At block 830, the computing device may determine if the user's gaze has changed. Foveation can be based on gaze detection and a region of interest (e.g., a focal region) of the user. The gaze of a user can change based on intrinsic or extrinsic events. Extrinsic events include events that are not related to the XR device, such as local motion detected within a scene (e.g., a user interface element moves into the field of view). Intrinsic events include events that are related to the state or operation of the XR device, such as global motion applied to the XR device. For example, the computing device may determine that the user's gaze has moved to a location in the scene that was previously in the peripheral region. If the computing device determines the gaze changes at block 820, the computing device proceeds to block 832. However, if the computing device determines the gaze does not change, the computing device proceeds to block 840.

At block 832, the computing device may increase the frame rate of the peripheral region. For example, the computing device may increase the frame rate to 60 FPS. In addition, the computing device may also change the fovea region and the peripheral region.

At block 834, the computing device may then determine whether the gaze is deemed static or in motion. If the computing device determines the gaze change is continuing, the computing device may return to block 832 to increase the frame rate (e.g., to 90 FPS) of the peripheral region or maintain the current frame rate. If the computing device determines the gaze is deemed static, the computing device may return to block 802 to return to steady state operation.

At block 840, the computing device may determine if there is global motion (e.g., the user is rotating the computing device). For example, the computing device may determine that the user is rotating their head based on a gyroscope or the device is in motion based on an accelerometer. If the computing device determines there is global motion at block 840, the computing device proceeds to block 842. However, if the computing device determines there is no global motion, the computing device returns to block 802 for a next cycle.

At block 842, the computing device may increase the frame rate of the peripheral region. For example, the computing device may increase the frame rate to 60 FPS.

At block 844, the computing device may then determine whether the motion is continuing or whether it is deemed to have ended. If the computing device determines the motion is continuing, the computing device may return to block 842 to increase the frame rate (e.g., to 90 FPS) of the peripheral region or maintain the current frame rate. If the computing device determines the motion has ended, the computing device may return to block 802 to return to steady state operation.

In some cases, the computing device executing the process 800 may also incrementally decrease the frame rate of the peripheral region. For example, the computing device may decrease the frame rate from 30 FPS for every four frames when returning to block 802.

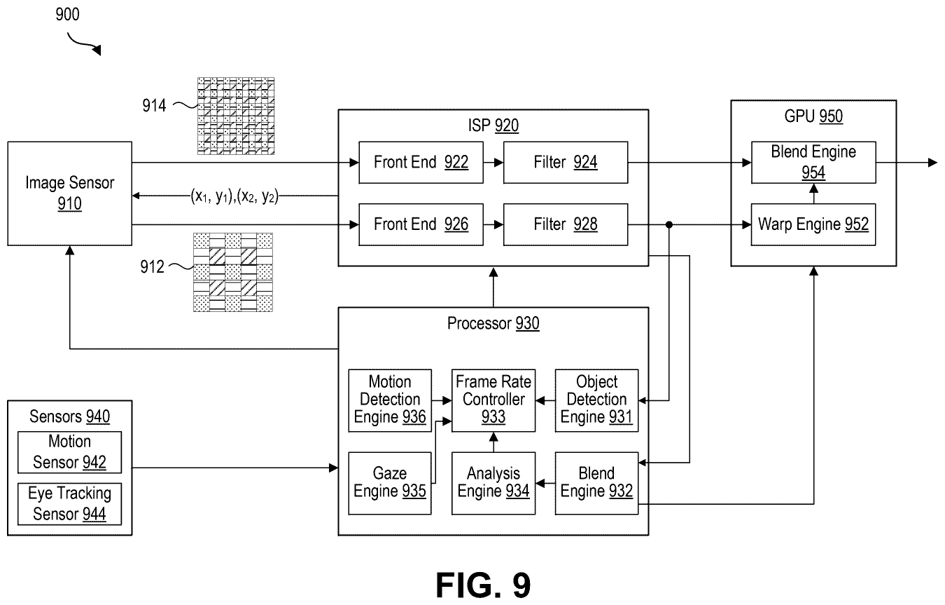

FIG. 9 is a block diagram illustrating an example of an XR system 900 with an image sensor configured to perform adaptive foveated sensing in accordance with some aspects of the disclosure. In some aspects, the XR system 900 includes an image sensor, an ISP 920, a processor 930, one or more sensors 940, and a GPU 950.

The image sensor 910 is configured to output a stream of images, such as a low-resolution image 912 and a high-resolution image 914. In this case, the low-resolution image 912 represents a full FOV of the image sensor 910 and includes a peripheral region and a fovea region. The high-resolution image 914 represents a partial FOV of the image sensor 910 and includes the fovea region. The frame rate of the stream of the low-resolution image 912 and the frame rate of the stream of the high-resolution image 914 may be different. For example, as described above, the frame rate of the low-resolution image 912 may be adaptively controlled based on intrinsic and extrinsic events.

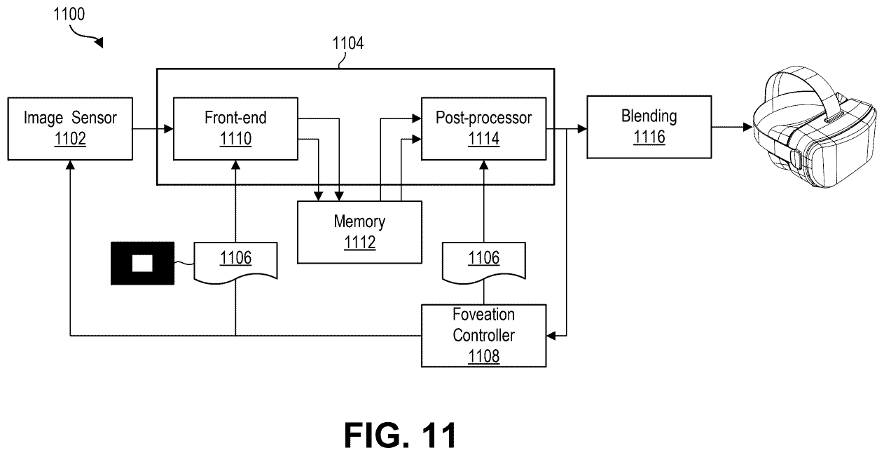

In some aspects, the image sensor 910 may be configured only to expose a portion of the photodiodes in a sensor array (e.g., the front-end engine 1110 in FIG. 11). In one aspect, a circuit controlling the sensor array may provide a start and end columns to the sensor array, thereby limiting the number of exposed photodiodes. In some aspects, the ISP 920 may send addresses (e.g., x₁,y₁ to x₂,y₂) to the image sensor 910 to limit the exposed sensor array, as shown in FIG. 9. In other cases, the processor 930 may also provide the addresses to the image sensor 910. In this manner, the image sensor 910 can capture a stream of frames having different image parameters. For example, the image sensor 910 can limit the number of exposed photodiodes to only capture a foveation region at a higher frame rate (e.g., 120 FPS) while capturing the entire FOV (e.g., all photodiodes) at a lower frame rate (e.g., 30 FPS). In some other aspects, the image sensor 910 can also generate multiple levels of foveation such a high-resolution fovea region, a mid-resolution medial fovea region that borders the high-resolution fovea region, and a low-resolution periphery region.

The high-resolution image 914 is provided to the ISP 920, and a front end 922 processes the low-resolution image 912, and then a filter 924 filters the high-resolution image 914. The low-resolution image 912 is also provided to the ISP 920, and a front end 926 processes the low-resolution image 912, and then a filter 928 filters the low-resolution image 912. In this case, the front end 922 and the front end 926 may be different based on the volume of processing, but also include common components such as correcting lens distortion. The filter 924 and the filter 928 may be different to allow heavier filtering to be performed on the low-resolution image 912. For example, additional color correction, tonal adjustment, and so forth may be performed on the high-resolution image 914 and omitted for the low-resolution image 912.

The low-resolution image 912 and the high-resolution image 914 may be provided to the processor 930 to perform various operations. Although illustrated as a single device, the processor 930 may include multiple cores including logical cores (e.g., arithmetic and logic units (ALUs)) and processing units specific to mathematical, matrix, and vector operations (e.g., a neural processing unit (NPU)). In one aspect, the low-resolution image 912 is provided to an object detection engine 931 for detecting local motion within a plurality of frames. The object detection engine 931 may be a machine learning model that determines optical flow information between subsequent frames. The object detection engine 931 determines whether there is local motion and outputs information to a frame rate controller identifying local motion or local motion has ended.

The ISP 920 may also output metadata of the low-resolution image 912 and the high-resolution image 914 (e.g., statistics and a histogram) to a blend engine 932. The blend engine 932 is configured to analyze the metadata and determine blend parameters that are output to the GPU 950. In some aspects, the metadata is provided to an analysis engine 934 to determine whether the metadata indicates that the image characteristics are changing. The analysis engine 934 outputs information to the frame rate controller 933.

In some aspects, the sensors 940 include a motion sensor 942 (e.g., an accelerometer, etc.) that detects motion of the XR system 900. The sensors 940 may also include an eye tracking sensor 944 for detecting gaze location of a user. The sensors 940 output various motion information to the processor 930. In some cases, the sensors 940 may also output information to the ISP 920 to process at least part of the motion information. For example, the ISP 920 may include a processing circuit specific to gaze detection, and the ISP 920 would then provide the gaze motion to the processor 930. The ISP 920 may also perform fovea region detection and use fovea information to control various aspects of the XR system 900. For example, the ISP 920 may be configured to generate a mask that identifies a focal region (e.g., the fovea region) that can be used by various components (e.g., the image sensor 910, the processor 930, the GPU 950, etc.) to control the foveation techniques described herein.

The processor 930 may also include a gaze engine 935 to process the motion information and determine whether the gaze is moving or has ended. The gaze engine 935 reports gaze movement or the end of gaze movement to the frame rate controller 933. The processor 930 may also include a motion detection engine 936 that detects global motion of the XR system 900 using, for example, the motion sensor 942. The motion detection engine 936 reports global motion or the end of global motion to the frame rate controller 933.

The frame rate controller 933 is configured to determine capture settings of the image sensor 910 based on the various analyses performed in the ISP 920 and the processor 930. For example, the frame rate controller 933 may be configured to perform the operations associated with the process 800 and control the frame rate of a peripheral region based on local motion, global motion, statistics changes, and gaze movement.

The low-resolution image 912 and the high-resolution image 914 are provided to the GPU 950. In some cases, the blend engine 932 may provide blend parameters (e.g., spatial gain modifiers) to correct for image differences between the low-resolution image 912 and the high-resolution image 914. Although not shown, the GPU 950 may also receive motion information from the processor 930 or the sensors 940 to identify movement of the XR system 900.

In some aspects, the low-resolution image 912 may be provided to a warp engine 952 that is configured to warp the image based on the motion information. For example, the time between a high frame rate fovea region at 120 FPS and a low frame rate peripheral region at 30 FPS can be 24.9 milliseconds, which can create visual artifacts based on time differences between the low-resolution image 912 and the high-resolution image 914. In this case, the warp engine 952 can use the motion information to warp the low-resolution image 912 to correspond to the high-resolution image 914. The warp engine 952 may also be configured to enhance the low-resolution image 912 to increase the resolution to match the high-resolution image 914. For example, conventional techniques include bilinear interpolation, bicubic interpolation, and so forth. In some cases, the warp engine 952 may include a machine learning (ML) engine configured for upscaling the low-resolution image 912.

The warped low-resolution image 912 and the high-resolution image 914 are provided to a blend engine 954 in the GPU 950 for blending the images into a single image. In some aspects, the blend engine 954 may use the blend parameters to forward correct for photometric differences in the warped low-resolution image 912 and the high-resolution image 914, as well as any additional processing to correct for artifacts that may occur in a boundary region around a peripheral edge defined by the high-resolution image 914.

The GPU 950 generates a stream of high-resolution images that are output to the XR system 900. In this case, the bandwidth is preserved within the XR system 900 to reduce photometric operations (e.g., filtering, object detection, etc.) of the processor, reduce memory operation (e.g., reads, writes), and decrease memory bandwidth consumption.

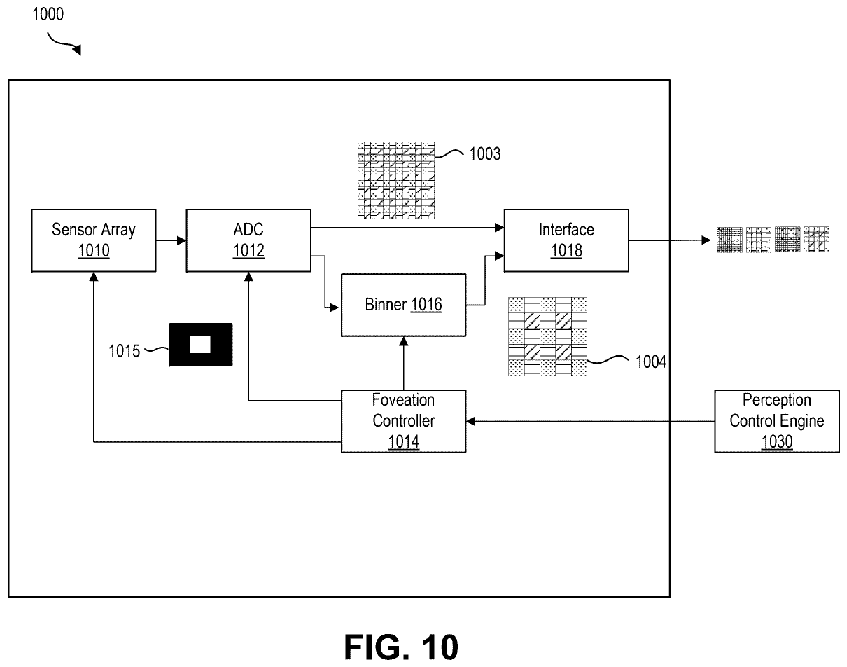

FIG. 10 illustrates an example block diagram of an image sensor 1000 (e.g., a VST sensor, such as the image sensor 910) configured to provide foveated portions of a frame to an ISP in accordance with some examples. The image sensor 1000 includes a sensor array 1010 that is configured to detect light and output a signal that is indicative of light incident to the sensor array 1010, such as an extended color filter array (XCFA) or a bayer filter, and provide the sensor signals to an ADC 1012. The ADC 1012 converts the analog sensor signals into a raw digital image. In one illustrative aspect, the ADC 1012 may also receive foveation information, such as a mask 1015, from a foveation controller 1014. The mask 1015 can be a bitmap as shown in FIG. 10 but may also be information such as a list of coordinates that define one or more foveation regions. For example, two points (e.g., x₁,y₁ and x₂,y₂) can identify a single foveation region. As illustrated in FIG. 10, the foveation controller 1014 receives information from a perception control engine 1030. The information from the perception engine can include a mask, a scaling ratio, frame rates, and other information such as interleaving, etc. For example, the perception control engine 1030 can include the functionality of a frame rate controller (e.g., the frame rate controller 518, etc.)

The foveation controller 1014 provides foveation information (e.g., mask 1015) to the ADC 1012 and, in response, the ADC 1012 may be configured to read out the raw digital image from the ADC 1012 based on the foveation information. For example, a pixel that corresponds to the black region of the mask is a peripheral region and is provided to a binner 1016, and a pixel that corresponds to the transparent region is the fovea region and the pixel is provided to the interface 1018. For example, the interface 1018 is configured to receive a high-resolution output 1003 from the ADC 1012. In some aspects, the ADC 1012 may also receive additional information such as interleaving information that identifies whether a fraction of the images (e.g., ½, etc.) should be foveated.

The binner 1016 is configured to receive the raw digital pixels from the ADC 1012 and a control signal from the foveation controller 1014 and generate a low-resolution image 1004. In one illustrative aspect, the control signal can be a scaling factor (e.g., 2, 4, etc.) that identifies an amount of pixels to converge to decrease the size of the peripheral region. An interface 1018 is configured to receive and output the high-resolution output 1003 and the low-resolution image 1004 for an ISP (e.g., ISP 506, ISP 706, ISP 920, etc.).

In other aspects, the binning may occur within the ADC 1012 itself based on data that is being read from a buffer. For example, as an image is being converted by the ADC and pixels can be temporarily stored in a buffer, and the readout of the pixels from the buffer can include a binning function that creates the high-resolution output 703 and the low-resolution output 704.

The foveation controller 1014 is also configured to control the sensor array 1010. For example, the foveation controller 1014 may provide addresses to the sensor array 1010 to expose a subset of rows and columns of the foveation controller 1014. In this case, the sensor array 1010 is configured to output sensor data corresponding to a full FOV (e.g., a peripheral region and a fovea region) at a low frame rate (e.g., 30 FPS) and sensor data corresponding to a partial FOV (e.g., the fovea region) at a high frame rate (e.g., 90 FPS). In this case, partial FOV frames are interleaved with the full FOV and enable high frame rates for the fovea region. This reduces power consumption and bandwidth requirements of the image sensor 1000.

FIG. 11 illustrates an example block diagram of an XR system 1100 with an image sensor 1102 (e.g., a VST sensor) configured to provide a frame to an ISP 1104 that performs foveation in accordance with some examples. FIG. 11 illustrates an example of foveating a frame or image into fovea regions and peripheral portions based on a mask 1106 provided by a foveation controller 1108 that detected the fovea region (e.g., ROI) of a previous frame. In some aspects, an image sensor 1102 provides image data without any cropping to a front-end engine 1110 that is part of an ISP 1104. In some cases, the front-end engine 1110 crops the frame into a fovea region (corresponding to the ROI) and the peripheral region based on the mask 1106. The front-end engine 1110 may downscale or downsample the peripheral region stream to conserve bandwidth. The front-end engine 1110 may process the fovea region stream using fewer image signal processing operations for the peripheral region of the frame(s) as compared to image signal processing operations performed for the ROI/fovea region of the frame(s), such as by performing basic corrective measures such as tone correction. The front-end engine 1110 can identify the fovea region/ROI based on the mask received from the ROI engine.

The front-end engine 1110 may transmit a first stream including the fovea region/ROI of the frame and a second stream including the peripheral region of the frame to a post-processing engine 1114. In some cases, the fovea region/ROI of the frame and a second stream including the peripheral region of the frame may need to be temporarily stored in the memory 1112 until the images are required by the post-processing engine 1114. In this example, the peripheral region consumes less memory based on the lower resolution, which saves energy by requiring the memory 1112 to write less content and decreases bandwidth consumption. The post-processing engine 1114 can read the fovea region stream and the peripheral region stream in the memory 1112 and process one or more of the streams. In some cases, the post-processing engine 1114 can use the mask to control various additional processing functions, such as edge detection, color saturation, noise reduction, tone mapping, etc. In some aspects, the post-processing engine 1114 is more computationally expensive, and providing a mask 1106 to perform calculations based on a particular region can significantly reduce the processing cost of various corrective measures. The post-processing engine 1114 provides the processed frames to the blending engine 1116 for blending the frames and other rendered content into a single frame, which is output to display panels of the XR system 1100. The post-processing engine 1114 also provides the processed frames to the foveation controller 1108, which predicts a mask 1106 for the next frame based on the processed frames and sensor information from various sensors.

The foveation controller 1108 is also configured to control frame rates of the fovea region and the peripheral region. In some aspects, the foveation controller 1108 may be able to control the image sensor 1102 to adaptively change the fovea region, reducing bandwidth within the XR system 1100.

In the illustrative aspects of FIG. 11, the foveated sensing/foveation of the frame is performed in the ISP 1104 itself. The front-end engine 1110 and the post-processing engine 1114 divide the ISP 1104 into two logical blocks to reduce the bandwidth of the image streams before storing the images in memory.

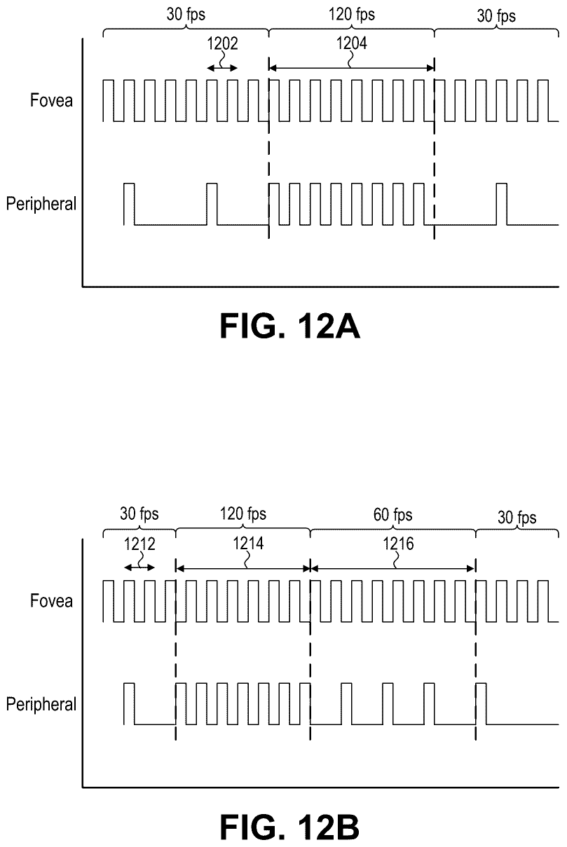

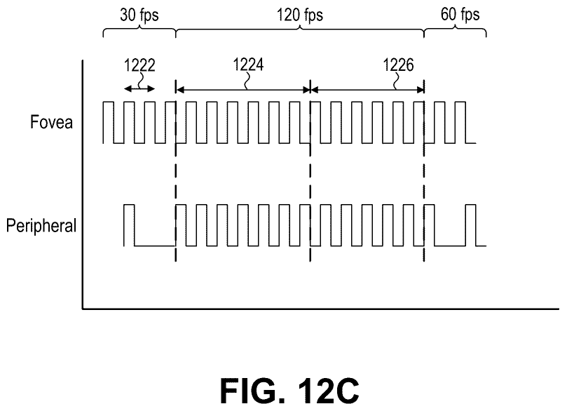

FIGS. 12A, 12B, and 12C illustrate operation of a frame rate controller in accordance with some aspects of the disclosure. In one aspect, FIG. 12A illustrates a timing diagram of a frame rate controller for controlling the generation of an image of a fovea region and a peripheral region. In FIG. 12A, initially a fovea region is generating images at 120 FPS and a peripheral region is generating images at 30 FPS to preserve power and bandwidth. An event is detected at reference label 1202 by one of a motion sensor (e.g., global motion), an event detection engine (e.g., local motion), an eye tracking sensor (e.g., gaze movement), and an analysis engine (e.g., photometric changes in the captured images). As a result, the device increases the frame rate of the peripheral region to 120 FPS. The event is continually monitored for duration 1204 until the device detects, at the end of duration 1204, and the event has ended. Accordingly, the device continues to maintain the fovea region generation at 120 FPS and reduces the frame rate of the peripheral region to 30 FPS.

In another aspect, the frame rates can be adaptively controlled to incrementally increase or decrease the frame rate. FIG. 12B illustrates an exponential decrease in frame rate after an event is detected at reference label 1212 by one of a motion sensor (e.g., global motion), an object detection engine (e.g., local motion), an eye tracking sensor (e.g., gaze movement), and an analysis engine (e.g., photometric changes in the captured images). For example, as shown in FIG. 12B, the device Increases the frame rate of the peripheral region to 120 FPS. The duration 1214 is a buffer to stabilize the frame rate and prevent rapid increases or decreases in frame rate. At the end of duration 1214, the device reduces the frame rate generation of the peripheral region to 60 FPS. The event is continually monitored for duration 1216 until the device detects, at the end of duration 1216, and the event has ended. Accordingly, the device continues to maintain the fovea region generation at 120 FPS and reduces the frame rate of the peripheral region to 30 FPS.

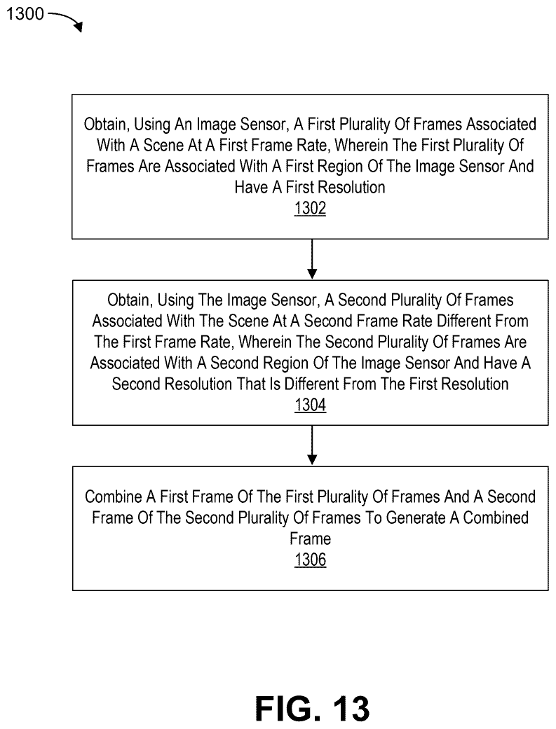

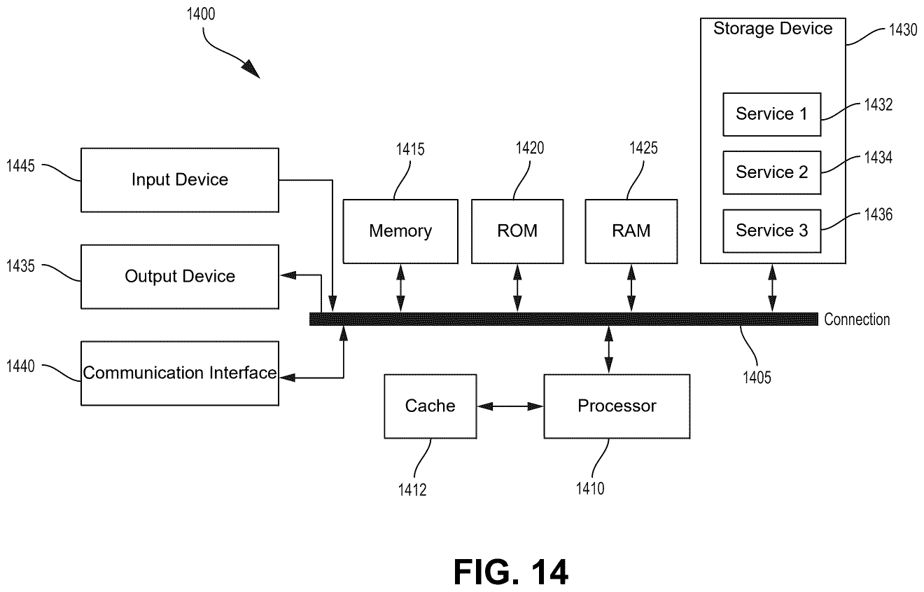

In another aspect, a hysteresis can be applied to the event detections to incrementally decrease frame rate based on motion. FIG. 12C illustrates a hysteresis in after an event is detected at reference label 1222 by one of a motion sensor (e.g., global motion), an object detection engine (e.g., local motion), an eye tracking sensor (e.g., gaze movement), and an analysis engine (e.g., photometric changes in the captured images). For example, as shown in FIG. 12B, the device increases the frame rate of the peripheral region to 120 FPS. During the duration 1224, the device buffers the frame rate to prevent increase or decrease. In some cases, the device monitors the event to ensure that the event has ended. In some aspects, the hysteresis can be associated with the detected event (e.g., local motion of an object is relatively static) during duration 1226. At the end of duration 1226, the device reduces the frame rate of the peripheral region to 30 FPS. FIG. 13 is a flowchart illustrating an example process 1300 for processing images in accordance with aspects of the present disclosure. The process 1300 can be performed by a computing device (or apparatus) or a component (e.g., a chipset, codec, etc.) of the computing device. The computing device may be a mobile device (e.g., a mobile phone), a network-connected wearable such as a watch, an XR device (e.g., a VR device or AR device), a vehicle or component or system of a vehicle, or other types of computing device. The operations of the process 1300 may be implemented as software components that are executed and run on one or more processors (e.g., CPU 102, GPU 104, DSP 106, and/or NPU 108 of FIG. 1, the processor 1410 of FIG. 14, or other processor(s)). Further, the transmission and reception of signals by the computing device in the process 1300 may be enabled, for example, by one or more antennas, one or more transceivers (e.g., wireless transceiver(s)), and/or other communication components of the computing device.

At block 1302, the computing device (or component thereof) may obtain, using an image sensor (or obtain from the image sensor), a first plurality of frames associated with a scene at a first frame rate. The first plurality of frames are associated with a first region of the image sensor and have a first resolution. In some aspects, multiple levels of foveation can be captured. For example, the first region can be a fovea region (e.g., a first FOV), the second region can be region bordering the fovea region (e.g., a medial resolution), and the third region can be the periphery region (e.g., a full FOV of the scene).

At block 1304, the computing device (or component thereof) may obtain, using the image sensor (or obtain from the image sensor), a second plurality of frames associated with the scene at a second frame rate different from the first frame rate. The second frame rate is different from the first frame rate. The second plurality of frames may be associated with a second region of the image sensor and have a second resolution is different from the first resolution. In some aspects, the second region is larger than the first region. In one illustrative example, the second region is the periphery region (e.g., a full FOV of the image sensor) and include the fovea region, and the first region (e.g., the first FOV) is only the fovea region.

At block 1306, the computing device (or component thereof) may combine the first plurality of frames and the second plurality of frames to generate a combined frame. The computing device (or component thereof) may, as part of combining the frame, warp a first frame from the second plurality of frames, the first frame being obtained before a second frame from the first plurality of frames, combining the warped first frame with the second frame, and blending a boundary region between warped first frame and the second frame. For example, the first frame may be captured at 120 FPS and the second frame may be captured at 30 FPS. The second frame may be captured before the first frame and may be warped to match first frame.

In some aspects, the computing device (or component thereof) may adjust readout portions of the image sensor based on whether a current time corresponds to one of the first frame rate and the second frame rate. For example, the computing device (or component thereof) can control the frame rate (e.g., increase or decrease) and may change an exposed area of photodiodes of the sensor array. For example, the second region is read out at a rate of 120 FPS, and the first region and the fovea region are read out at a rate of 30 FPS.

In some aspects, the computing device (or component thereof) may detect a frame rate change event associated with the scene. In some aspects, the frame rate change events can be intrinsic or extrinsic events. In one example, to detect the frame rate change event, the computing device (or component thereof) can detect a change in a characteristic associated with the scene. An example of a characteristic associated with the scene can include lighting, but other characteristics can be included as well. In another example, to detect the frame rate change event, the computing device (or component thereof) can detect motion applied to the image sensor based on motion data detected by a motion sensor. In another example, to detect the frame rate change event, the computing device (or component thereof) can detect a change in a focal area of the scene based on motion data detected by an eye tracking sensor. In another example, to detect the frame rate change event, the computing device (or component thereof) can detect motion of an object within a peripheral edge of a frame from one of the second plurality of frames. Other frame rates changes can be included based on the aspects described herein. The computing device (or component thereof) may determine an end of the frame rate change event, and adjust the readout portions of the image sensor from the second frame rate to the first frame rate based on the end of the frame rate change event. In some cases, the end of the frame rate change event can be detected based on a hysteresis.

In some cases, the frames can be downsampled using one or more components of the computing device. In one aspect, the computing device (or component thereof) may downsample each frame of the second plurality of frames in the image sensor. In other aspects, the computing device (or component thereof) may downsample each frame of the second plurality of frames in an image signal processor.

The computing device (or component thereof) may also display the combined frame. For example, the computing device (or component thereof) may display at least one frame of at least one of the first plurality of frames or the second plurality of frames. In some cases, the computing device (or component thereof) may also display virtual content augmenting the at least one frame based on image data from a processor.

In some aspects, the computing device (or component thereof) may receive eye gaze information from a gaze detection sensor. The eye gaze information may identify a focal region or an ROI, which corresponds to the first region. The computing device (or component thereof) may also obtain, using the image sensor, a third plurality of frames associated with the scene at the first frame rate based on gaze information from the gaze detection sensor. The third plurality of frames are associated with a third region of the image sensor and have the first resolution. In some cases, the computing device (or component thereof) may also obtain, using the image sensor, a fourth plurality of frames associated with the scene at the second frame rate. The fourth plurality of frames are associated with the second region of the image sensor and have the second resolution. The third plurality of frames and the fourth plurality of frames may be combined as described above.

The computing device (or component thereof) may also obtain, using the image sensor, a third plurality of frames associated with the scene, where the third plurality of frames are associated with a third region of the image sensor and have a third resolution that is different from the first resolution. The third region is larger than the first region and smaller than the second region. For example, the second region may be the full region of the image sensor, the third region may be a partial region of the image sensor that includes a fovea region, and the first region may only be a fovea region that in included with the partial region.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive IP-based data or other type of data.

The components of the computing device can be implemented in circuitry. For example, the components can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein.

The process 1300 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 1300 and/or any other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 14 is a diagram illustrating an example of a system for implementing certain aspects of the present technology. In particular, FIG. 14 illustrates an example of computing system 1400, which may be for example any computing device making up internal computing system, a remote computing system, a camera, or any component thereof in which the components of the system are in communication with each other using connection 1405. Connection 1405 may be a physical connection using a bus, or a direct connection into processor 1410, such as in a chipset architecture. Connection 1405 may also be a virtual connection, networked connection, or logical connection.

In some embodiments, computing system 1400 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 1400 includes at least one processing unit (CPU or processor) 1410 and connection 1405 that communicatively couples various system components including system memory 1415, such as ROM 1420 and RAM 1425 to processor 1410. Computing system 1400 may include a cache 1412 of high-speed memory connected directly with, in close proximity to, or integrated as part of processor 1410.

Processor 1410 may include any general purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 includes an input device 1445, which may represent any number of input mechanisms, such as a microphone for speech, a touch-sensitive screen for gesture or graphical input, keyboard, mouse, motion input, speech, etc. Computing system 1400 may also include output device 1435, which may be one or more of a number of output mechanisms. In some instances, multimodal systems may enable a user to provide multiple types of input/output to communicate with computing system 1400.

Computing system 1400 may include communications interface 1440, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1440 may also include one or more Global Navigation Satellite System (GNSS) receivers or transceivers that are used to determine a location of the computing system 1400 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, RAM, static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1430 may include software services, servers, services, etc., that when the code that defines such software is executed by the processor 1410, it causes the system to perform a function. In some embodiments, a hardware service that performs a particular function may include the software component stored in a computer-readable medium in connection with the necessary hardware components, such as processor 1410, connection 1405, output device 1435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“&lt;”) and greater than (“&gt;”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for generating one or more frames. The apparatus includes at least one memory and at least one processor coupled to the at least one memory and configured to: obtain, from an image sensor, a first plurality of frames associated with a scene at a first frame rate, wherein the first plurality of frames are associated with a first region of the image sensor and have a first resolution; obtain, from the image sensor, a second plurality of frames associated with the scene at a second frame rate different from the first frame rate, wherein the second plurality of frames are associated with a second region of the image sensor and have a second resolution that is different from the first resolution; and combine a first frame of the first plurality of frames and a second frame of the second plurality of frames to generate a combined frame.

Aspect 2. The apparatus of Aspect 1, wherein the second region is larger than the first region.

Aspect 3. The apparatus of any of Aspects 1 to 2, wherein the at least one processor is configured to: detect a frame rate change event associated with the scene; and increase the second frame rate based on the frame rate change event.

Aspect 4. The apparatus of Aspect 3, wherein the at least one processor is configured to: detect a change in a characteristic associated with the scene; detect motion applied to the image sensor based on motion data detected by a motion sensor; detect a change in a focal area of the scene based on motion data detected by an eye tracking sensor; or detect motion of an object within a peripheral edge of a frame from one of the second plurality of frames.

Aspect 5. The apparatus of Aspect 4, wherein the characteristic includes a lighting characteristic.

Aspect 6. The apparatus of any of Aspects 3 to 5, wherein the at least one processor is configured to: determine an end of the frame rate change event; and decrease the second frame rate based on the end of the frame rate change event.

Aspect 7. The apparatus of any of Aspects 1 to 6, wherein the at least one processor is configured to: adjust readout portions of the image sensor based on whether a current time corresponds to one of the first frame rate and the second frame rate.

Aspect 8. The apparatus of any of Aspects 1 to 7, wherein the at least one processor is configured to: warp the second frame from the second plurality of frames to correspond to the first frame, wherein the second frame is obtained before the first frame; combine the warped second frame with the first frame; and blend a boundary region between warped second frame and the first frame.

Aspect 9. The apparatus of any of Aspects 1 to 8, wherein the at least one processor is configured to: downsample each frame of the second plurality of frames in the image sensor; or downsample each frame of the second plurality of frames in an image signal processor.

Aspect 10. The apparatus of any of Aspects 1 to 9, wherein the at least one processor is configured to: display the combined frame; or display the combined frame augmented with virtual content based on image data from a processor.

Aspect 11. The apparatus of any of Aspects 1 to 10, wherein the at least one processor is configured to: determine the first region based on an eye gaze information from a gaze detection sensor.

Aspect 12. The apparatus of any of Aspects 1 to 11, wherein the at least one processor is configured to: obtain, from the image sensor, a third plurality of frames associated with the scene at the first frame rate based on a gaze information from a gaze detection sensor, wherein the third plurality of frames are associated with a third region of the image sensor and have the first resolution; and obtain, from the image sensor, a fourth plurality of frames associated with the scene at the second frame rate, wherein the fourth plurality of frames are associated with the second region of the image sensor and have the second resolution.

Aspect 13. The apparatus of any of Aspects 1 to 12, wherein the at least one processor is configured to: obtain, from the image sensor, a third plurality of frames associated with the scene, wherein the third plurality of frames are associated with a third region of the image sensor and have a third resolution that is different from the first resolution, wherein the third region is larger than the first region and smaller than the second region.

Aspect 14. The apparatus of Aspect 13, wherein the at least one processor is configured to obtain the third plurality of frames at a third frame rate that is less than or equal to the first frame rate.

Aspect 15. A method of generating one or more frames, comprising: obtaining, using an image sensor, a first plurality of frames associated with a scene at a first frame rate, wherein the first plurality of frames are associated with a first region of the image sensor and have a first resolution; obtaining, using the image sensor, a second plurality of frames associated with the scene at a second frame rate different from the first frame rate, wherein the second plurality of frames are associated with a second region of the image sensor and have a second resolution that is different from the first resolution; and combining a first frame of the first plurality of frames and a second frame of the second plurality of frames to generate a combined frame.

Aspect 16. The method of Aspect 15, wherein the second region is larger than the first region.

Aspect 17. The method of any of Aspects 15 to 16, further comprising: detecting a frame rate change event associated with the scene; and increasing the second frame rate based on the frame rate change event.

Aspect 18. The method of Aspect 17, wherein detecting the frame rate change event comprises at least one of: detecting a change in a characteristic associated with the scene; detecting motion applied to the image sensor based on motion data detected by a motion sensor; detecting a change in a focal area of the scene based on motion data detected by an eye tracking sensor; or detecting motion of an object within a peripheral edge of a frame from one of the second plurality of frames.

Aspect 19. The method of Aspect 18, wherein the characteristic includes a lighting characteristic.

Aspect 20. The method of any of Aspects 17 to 19, further comprising: determining an end of the frame rate change event; and decreasing the second frame rate based on the end of the frame rate change event.

Aspect 21. The method of any of Aspects 15 to 20, further comprising: adjusting readout portions of the image sensor based on whether a current time corresponds to one of the first frame rate and the second frame rate.

Aspect 22. The method of any of Aspects 15 to 21, wherein combining the first frame and the second frame comprises: warping the second frame from the second plurality of frames to correspond to the first frame, wherein the second frame is obtained before the first frame; combining the warped second frame with the first frame; and blending a boundary region between warped second frame and the first frame.

Aspect 23. The method of any of Aspects 15 to 22, further comprising: downsampling each frame of the second plurality of frames in the image sensor; or downsampling each frame of the second plurality of frames in an image signal processor.

Aspect 24. The method of any of Aspects 15 to 23, further comprising: displaying the combined frame; or displaying the combined frame augmented with virtual content based on image data from a processor.

Aspect 25. The method of any of Aspects 15 to 24, wherein the first region is determined based on an eye gaze information from a gaze detection sensor.

Aspect 26. The method of any of Aspects 15 to 25, further comprising: obtaining, using the image sensor, a third plurality of frames associated with the scene at the first frame rate based on a gaze information from a gaze detection sensor, wherein the third plurality of frames are associated with a third region of the image sensor and have the first resolution; and obtaining, using the image sensor, a fourth plurality of frames associated with the scene at the second frame rate, wherein the fourth plurality of frames are associated with the second region of the image sensor and have the second resolution.

Aspect 27. The method of any of Aspects 15 to 26, further comprising: obtaining, using the image sensor, a third plurality of frames associated with the scene, wherein the third plurality of frames are associated with a third region of the image sensor and have a third resolution that is different from the first resolution, wherein the third region is larger than the first region and smaller than the second region.

Aspect 28. The method of Aspect 27, wherein the third plurality of frames is obtained at a third frame rate that is less than or equal to the first frame rate.

Aspect 29. A non-transitory computer-readable medium having stored thereon instructions that, when executed by at least one processor, cause the at least one processor to perform operations according to any of Aspects 15 to 28.

Aspect 30. An apparatus for obtaining one or more images, comprising one or more means for performing operations according to any of Aspects 15 to 28.

What is claimed is:

1. An apparatus for generating one or more frames, comprising:
at least one memory; and
at least one processor coupled to the at least one memory and configured to:
obtain, from an image sensor, a first plurality of frames associated with a scene at a first frame rate, wherein the first plurality of frames are associated with a first region of the image sensor and have a first resolution;
obtain, from the image sensor, a second plurality of frames associated with the scene at a second frame rate different from the first frame rate, wherein the second plurality of frames are associated with a second region of the image sensor and have a second resolution that is different from the first resolution; and
combine a first frame of the first plurality of frames and a second frame of the second plurality of frames to generate a combined frame.

2. The apparatus of claim 1, wherein the second region is larger than the first region.

3. The apparatus of claim 1, wherein the at least one processor is configured to:
detect a frame rate change event associated with the scene; and
increase the second frame rate based on the frame rate change event.

4. The apparatus of claim 3, wherein at least one processor is configured to:
detect a change in a characteristic associated with the scene;
detect motion applied to the image sensor based on motion data detected by a motion sensor;
detect a change in a focal area of the scene based on motion data detected by an eye tracking sensor; or
detect motion of an object within a peripheral edge of a frame from one of the second plurality of frames.

5. The apparatus of claim 4, wherein the characteristic includes a lighting characteristic.

6. The apparatus of claim 3, wherein the at least one processor is configured to:
determine an end of the frame rate change event; and
decrease the second frame rate based on the end of the frame rate change event.

7. The apparatus of claim 1, wherein the at least one processor is configured to:
adjust readout portions of the image sensor based on whether a current time corresponds to one of the first frame rate and the second frame rate.

8. The apparatus of claim 1, wherein the at least one processor is configured to:
warp the second frame from the second plurality of frames to correspond to the first frame, wherein the second frame is obtained before the first frame;
combine the warped second frame with the first frame; and
blend a boundary region between warped second frame and the first frame.

9. The apparatus of claim 1, wherein the at least one processor is configured to:
downsample each frame of the second plurality of frames in the image sensor; or
downsample each frame of the second plurality of frames in an image signal processor.

10. The apparatus of claim 1, wherein the at least one processor is configured to:
display the combined frame; or
display the combined frame augmented with virtual content based on image data from a processor.

11. The apparatus of claim 1, wherein the at least one processor is configured to determine the first region based on an eye gaze information from a gaze detection sensor.

12. The apparatus of claim 1, wherein the at least one processor is configured to:
obtain, from the image sensor, a third plurality of frames associated with the scene at the first frame rate based on gaze information from a gaze detection sensor, wherein the third plurality of frames are associated with a third region of the image sensor and have the first resolution; and
obtain, from the image sensor, a fourth plurality of frames associated with the scene at the second frame rate, wherein the fourth plurality of frames are associated with the second region of the image sensor and have the second resolution.

13. The apparatus of claim 1, wherein the at least one processor is configured to:
obtain, from the image sensor, a third plurality of frames associated with the scene, wherein the third plurality of frames are associated with a third region of the image sensor and have a third resolution that is different from the first resolution, wherein the third region is larger than the first region and smaller than the second region.

14. The apparatus of claim 13, wherein the at least one processor is configured to obtain the third plurality of frames at a third frame rate that is less than or equal to the first frame rate.

15. A method of generating one or more frames, comprising:
obtaining, using an image sensor, a first plurality of frames associated with a scene at a first frame rate, wherein the first plurality of frames are associated with a first region of the image sensor and have a first resolution;
obtaining, using the image sensor, a second plurality of frames associated with the scene at a second frame rate different from the first frame rate, wherein the second plurality of frames are associated with a second region of the image sensor and have a second resolution that is different from the first resolution; and
combining a first frame of the first plurality of frames and a second frame of the second plurality of frames to generate a combined frame.

16. The method of claim 15, wherein the second region is larger than the first region.

17. The method of claim 15, further comprising:
detecting a frame rate change event associated with the scene;
increasing the second frame rate based on the frame rate change event;
determining an end of the frame rate change event; and
decreasing the second frame rate based on the end of the frame rate change event, wherein detecting the frame rate change event comprises at least one of:
detecting a change in a characteristic associated with the scene;
detecting motion applied to the image sensor based on motion data detected by a motion sensor;
detecting a change in a focal area of the scene based on motion data detected by an eye tracking sensor; or
detecting motion of an object within a peripheral edge of a frame from one of the second plurality of frames.

18. The method of claim 15, further comprising:
adjusting readout portions of the image sensor based on whether a current time corresponds to one of the first frame rate and the second frame rate.

19. The method of claim 15, wherein combining the first frame and the second frame comprises:
warping the second frame from the second plurality of frames to correspond to the first frame, wherein the second frame is obtained before the first frame;
combining the warped second frame with the first frame; and
blending a boundary region between warped second frame and the first frame.

20. The method of claim 15, further comprising:
downsampling each frame of the second plurality of frames in the image sensor; or
downsampling each frame of the second plurality of frames in an image signal processor.
